(19) United States
(12) Patent Application Publication
(10) Pub. No.: US 2026/0366812 A1
(43) Pub. Date: Nov. 19, 2026

(54) MODULAR DRYING RACK WITH ACTIVE AIRFLOW AND SLOTTED, RIDGED TRAY

(71) Applicant: Benjamin Brown, Brooklyn, NY (US)

(72) Inventor: Benjamin Brown, Brooklyn, NY (US)

(21) Appl. No.: 19/674,906

(22) Filed: May 12, 2026

Related U.S. Application Data
(60) Provisional application No. 63/805,192, filed on May 13, 2025.

(51) Int. Cl. F26B 9/00; A47L 19/04

(52) U.S. Cl. CPC F26B 9/003; A47L 19/04

(57) ABSTRACT

The rack system is designed for enhanced drying of small components such as baby bottles, bottle nipples, breast pump parts, and pacifiers. The rack system utilizes a ridged tray with slits running across the peaks of the ridges. The tray is then nested within a base that houses a detachable fan. The airflow generated by the fan, combined with the uniquely contoured tray, accelerates drying time and prevents moisture accumulation that can lead to bacterial or mold growth.

### CROSS REFERENCE TO RELATED APPLICATIONS

This application claims priority to U.S. Provisional Patent Application No. 63/805,192, filed May 13, 2025, the entire contents of which are incorporated herein by reference.

### BACKGROUND

Conventional drying racks, especially those designed for baby bottles or household use, often rely on passive drying that limits and even inhibits airflow. Moisture tends to pool in or around components, especially those with narrow openings or tapering structures. Water also collects in the basin below the object where it can also be slow to dry and support mold and bacteria growth. Dry components are critical for use with babies and infants to reduce the risk of bacteria, mold, or other contaminants, which poses a risk to the wellness of the child. Dry components are also critical for storing these objects such as baby bottles and bottle nipples. Existing systems fail to provide adequate separation between the component and the surface it rests on, or enough airflow, slowing down evaporation and drying time, leading to objects remaining wet when they are needed again for use, and risking bacterial and mold growth.

### SUMMARY

Therefore, in order to overcome the drawbacks of the existing system, the need exists for a drying system that combines structural elevation, active airflow, and modularity to enhance drying performance and allow for the drying of a diverse set of components. This is also true of other products used for infant care, as well as for drying other common household items, or even items in a laboratory or medical setting.

The rack system of the disclosed invention is constructed to hold and orient pieces to maximize airflow for small parts that are customary in baby bottles, breast pumps, pacifiers, and other tools and equipment for feeding and caring for infants. The open air design of the rack system of the disclosed invention minimizes moisture entrapment and reduces mold and bacteria risk. A protruding portion on the drying tray which minimizes contact points for enhanced airflow and accommodates a wide range of item sizes. Slots or any through openings on the protruding portions allow active airflow generated by the fan to penetrate components. Angled troughs between the ridge peaks enhance water runoff.

These advantages and others are achieved, for example, by a rack system configured to dry objects. The rack system includes a base providing an interior space and having an open top surface open to the interior space, a tray placed on or inside the base covering the interior space of the base, and at least one fan unit coupled to the base and comprising at least one fan configured to provide an airflow into the interior space of the base. The tray includes a plurality of protruding portions and one or more of the protruding portions include at least one through opening that is open to the interior space of the base.

The tray may include a channel placed at a first end of the tray to collect fluid flowing through the tray. The protruding portions may include a plurality of ridges spaced apart from each other extending between a first end of the tray and a second end of the tray and a plurality of troughs between the plurality of ridges. Bottoms of the troughs along a line between the first and second ends of the tray may be inclined with respect to the surface of the base. Peaks of the ridges along a line between the first and second ends of the tray may be parallel to the surface of the base. The rack system includes one or more poles extending upwardly from the tray and configured to be coupled to the objects placed on the tray. The poles may have hollow cylinder shapes and may include holes formed on a side of the hollow cylinder shapes of the poles. The holes are open to the interior space of the base through the through openings of the ridges. The through opening may include one or more slots. The through opening may include one or more holes. The tray may be detachably placed on the base. The fan may be detachable from the fan unit.

These advantages and others are achieved, for example, by another embodiment of a rack system configured to dry objects. The rack system includes a main base providing a main interior space and comprising one or more tray bases installed on the main base, one or more trays configured to be placed on or inside the tray bases, and at least one fan unit coupled to the main base and including at least one fan configured to provide an airflow into the main interior space of the main base. Each tray base provides a tray base interior space and has an open top surface open to the tray base interior space. The tray base interior spaces of the one or more tray bases are open to the main interior space. The tray includes a plurality of protruding portions. One or more of the protruding portions include at least one through opening that is open to the tray base interior space of the corresponding tray base.

The tray bases may be arranged vertically along the height of the main base. The main base may be tapered along a height of the main base. The tray bases may be detachable from the main base.

### BRIEF DESCRIPTION OF THE DRAWINGS

The preferred embodiments described herein and illustrated by the drawings hereinafter are to illustrate and not to limit the invention, where like designations denote like elements.

FIG. 1 is a perspective view of a rack system of the disclosed invention configured to dry items or objects.

FIG. 2 is a top view of the rack system viewed from the top.

FIG. 3 is a cross-sectional view cut along line A-A′ shown in FIG. 1.

FIG. 4 is a cross-sectional view cut along line B-B′ shown in FIG. 1.

FIG. 5A is a perspective view of another embodiment of the tray that can be used for the rack system of the disclosed invention.

FIG. 5B is a view of section C shown in FIG. 5A.

FIG. 6 shows an exemplary structure of the peg and pole.

FIGS. 7A-7B show diagrams illustrating configurations of fan installed in the base.

FIG. 8 shows another embodiment of a rack system (or a tower rack system) of the disclosed invention.

FIG. 9 is a diagram illustrating how items or objects may be placed on the tray to dry the items.

### DETAILED DESCRIPTION

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure, which is defined by the claims. It is also to be understood that the drawings included herewith only provide diagrammatic representations of the presently preferred structures of the present invention and that structures falling within the scope of the present invention may include structures different than those shown in the drawings.

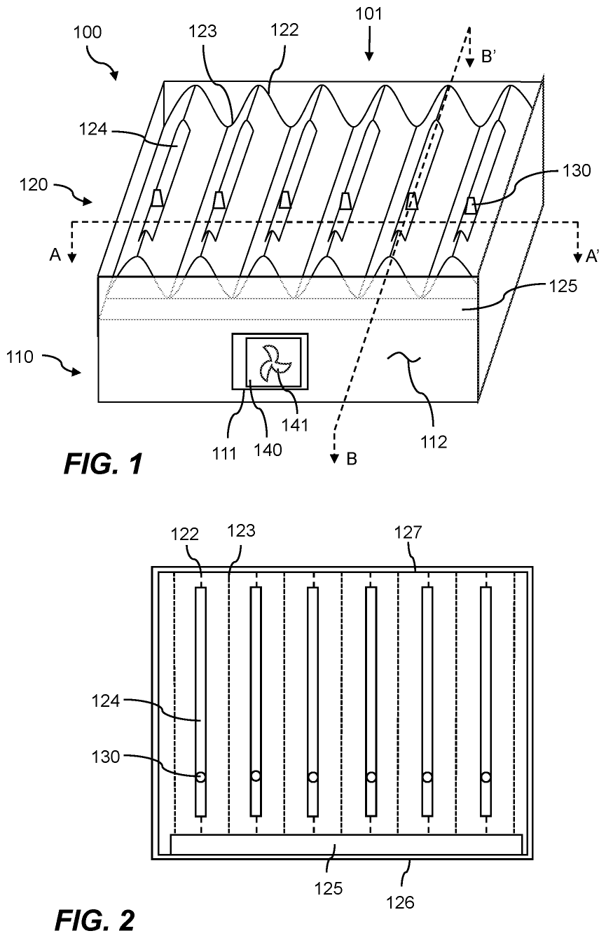

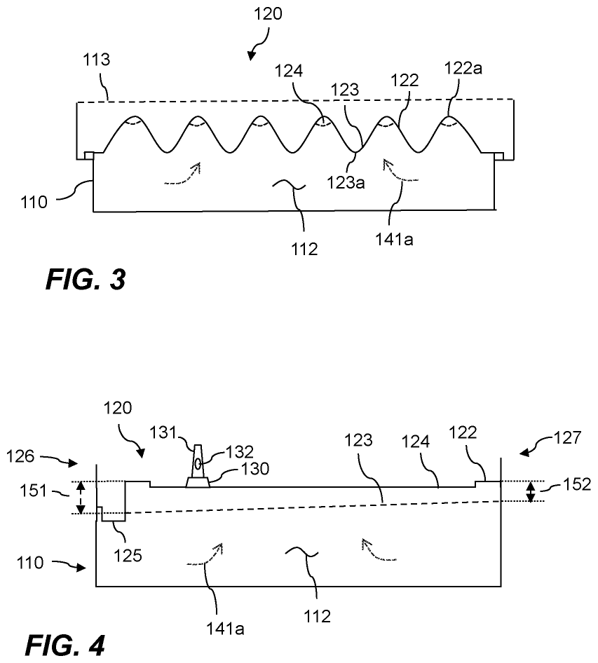

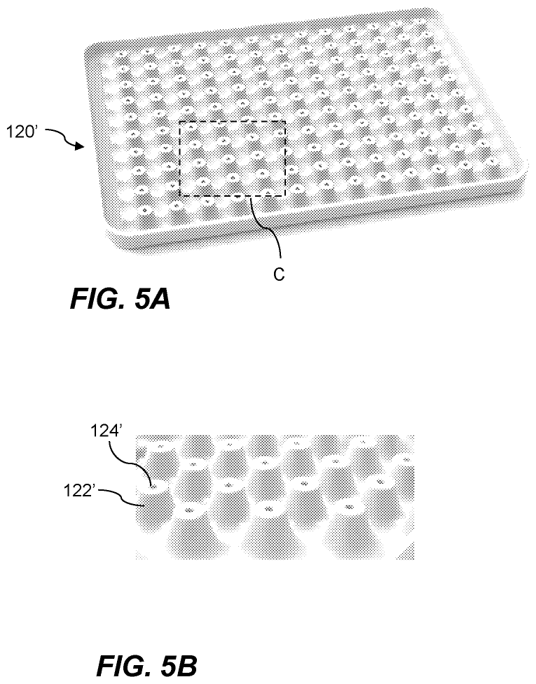

With reference to FIG. 1, shown is a perspective view of the rack system 100 of the disclosed invention configured to dry objects. With reference to FIG. 2, shown is a top view of the rack system 100 viewed from the direction 101. With reference to FIG. 3, shown is a cross-sectional view cut along line A-A′ shown in FIG. 1. With reference to FIG. 4, shown is a cross-sectional view cut along line B-B′ shown in FIG. 1. With reference to FIG. 5A, shown is a perspective view of another embodiment of the tray that can be used for the rack system 100 of the disclosed invention. With reference to FIG. 5B, shown is a view of section C shown in FIG. 5A. For description purposes, the drawings are exaggerated.

Referring to FIGS. 1-5B, the rack system 100 includes base 110 that provides an interior space 112 and has an open top surface 113 open to the interior space 112. The rack system 100 includes tray 120 placed on or inside the base 110 covering the interior space 112 of the base 110. The tray 120 includes a plurality of ridges 122 spaced apart from each other extending between first end 126 of the tray 120 and second end 127 of the tray 120 and a plurality of troughs 123 between the plurality of ridges 122. The ridges 122 may be arranged parallel to each other. Alternatively, ridges 122 may not be straight or parallel to each other and may have curved sections. Each ridge 122 includes at least one through opening 124 that is open to the interior space 112 of the base 110.

The base 110 may be equipped with recess or housing 111 for a detachable fan unit 140 that includes at least one fan 141 and a motor (not shown) to drive the fan 141. The fan 141 is configured to provide an airflow 141a into the interior space 112 of the base 110. The drying rack system 100 may include multiple fan units 140 and the fan unit 140 may be placed in any locations to improve the airflow 141a. The fan 141 may or may not be detachable from the fan unit 140.

FIGS. 1-4 show an exemplary structure of the tray 120 having ridges 122. However, the structure of the tray is not limited to the structure shown in FIGS. 1-4. The tray 120 may have different structures. For example, as shown in FIGS. 5A-5B, the tray 120′ may have protrusions 122′ protruding from a top surface of the tray 120′. Each protrusion 122′ or some protrusions 122′ may include at least one through opening 124′ that is open to the interior space 112 of the base 110. FIGS. 5A-5B are exemplary diagrams in which each protrusion 122′ has through opening 124′, but some protrusions 122′ may have through openings 124′ and the other protrusions may not have through openings. Herein, the ridges 122 and protrusions 122′ are referred to as protruding portions. The rack system 100 may include any shapes and structures of protruding portions 122, 122′ including straight lines and horizontal ridges.

Moreover, the through openings may be also formed on the portions of the tray between the protruding portions 122, 122′ or any portions of the tray. For example, the troughs 123 may have through openings open to the interior space 112.

FIGS. 1-5B shows exemplary structures of the tray. However, the rack system 100 may include any shapes and structures of the tray such as baskets and any shapes and structures of containers and plates. The tray, basket, or container of the disclosed invention may be configured to hold any items such as baby bottles, breast pumps, pacifiers, any types of objects, tools, equipment, and household items such as spoons and straws.

The rack system 100 may include any number of trays. For example, multiple trays may be placed on the base 110 side by side or multiple trays may be stacked. For example, the rack system 100 may include any combination of trays placed side by side and stacked vertically.

The rack system 100 includes channel 125 placed at the first end 126 of the tray 120 to collect fluid flowing through the troughs 123. In an embodiment, the peaks 122a of the ridges 122 along a line between the first and second ends 126, 127 of the tray 120 are parallel to the top surface 113 of the base 110, while the bottoms 123a of the troughs 123 along a line between the first and second ends 126, 127 of the tray 120 may be inclined with respect to the top surface 113 of the base 110. For example, as shown in FIG. 4, first depth 151 between the peak 122a of each ridge 112 and the bottom 123a of each trough 123 at the first end 126 of the tray 120 may be greater than second depth 152 between the peak 122a of each ridge 122 and the bottom 123a of each trough 123 at the second end 127 of the tray 120. However, in another embodiment, the troughs 123 may not be inclined, and may be parallel to the top surface 113 of the base 110.

In an embodiment, the through opening 124 of each ridge 122 may be a slot formed on the peak 122a of each ridge 122 along a line between the first and second ends 126, 127 of the tray 120. In another embodiment, the through opening may include a plurality of holes arranged on the peak 122a of each ridge 122 along a line between the first and second ends 126, 127 of the tray 120. In still another embodiment, the through opening 124 may be combinations of the slots and holes.

A slotted, ridged tray 120 nests atop the base 110 and supports the drying items 300 (see FIG. 9). The fan unit 140 blows air into interior space 112 of the base 110, and through opening 124 in the tray 120 where items to be dried are held. Raised ridges 122 on the tray 120 suspend the drying items, increasing airflow under and around the objects. The troughs 123 between the ridges 122 may be angled and allow excess water in the troughs 123 to flow to an edge channel or drainage chute 125. The modular configuration, in which the base 110, tray 120 and fan 141 are detachable, allows each component—fan, base, tray—to be cleaned or replaced individually. This facilitates the timely drying of such objects and also ensures ease of cleaning.

The rack system 100 is constructed to hold and orient pieces to maximize airflow for small parts that are customary in baby bottles, breast pumps, pacifiers, and other tools and equipment for feeding and caring for infants. For example, a popular baby bottle has a unique hose that descends into the bottle with an internal diameter of approximately 0.6 cm, and a nipple with an interior diameter of 0.8 cm. Similarly, popular bottle nipples have a rubber slot around the base of the nipple with a depth of 0.5 cm and a width of 0.6 cm. A popular pacifier has a cavity with an interior diameter of approximately 0.5 cm by 1.2 cm, and a depth of 2.5 cm, which often fills with water during washing. In addition, popular components for breast pumps have threading 0.3 cm apart. Small dimensions are common in these types of products, and the small dimensions, coupled with the surface tension of water, do not allow small water droplets to flow away from the component. With limited surface area of the water exposed to air when passively air dried, the water evaporates very slowly.

The slotted peaks of ridges 122 on the tray 120, which are spaced, for example, by 2.0 cm-4.0 cm, allow for these products to straddle across multiple peaks 122a and troughs 123, limiting the contact between the tray 120 and the object. For example, the bottle, which has an opening of approximately 6.0 cm, would straddle several peaks 122a and troughs 123 when rested upside down to dry on the tray 120. This maximizes airflow and allows for water to flow down into the troughs 123 between the peaks 122a and away from the drying object. Air drying is important because exposure to extreme or repeated heat can change the properties of the materials or products, such as their shape, and can also support the leaching of toxins and general degradation over time.

The same improvement in drying time with this design is also true with other types of bottles, nipples, pump parts, pacifiers and objects used to feed and care for infants. The same design can also reduce drying time for other household items such as cups, cutlery, plates, glassware, bottles, as well as medical or laboratory equipment, such as beakers, cylinders, piping, and a myriad of other objects.

Active airflow provided by the fan 141 and the unique ridged surface reduce drying time. Popular baby bottles taper dramatically at the top, and when placed on a conventional drying rack that holds bottles at an inverted angle, the water pools at the taper where it evaporates slowly. The regularly spaced ridges 122 on the tray 120 allow for items of varying sizes to be supported and dried. Larger items such as bottles can be completely upside down and exposed to air driven by the fan 141. Water can also flow out into the troughs 123, increasing the surface area of the water exposed to airflow 141a and thus reducing drying time. The same dynamic is true of other types of bottles that taper, both for babies and adults alike. Smaller items are also suspended as they straddle multiple ridge peaks 122a and troughs 123. The same principle is true for other ridge designs including ridges that are closer or further apart, ridges that are inconsistently spaced, ridges that are not straight or parallel to each other, ridges that have varying air flow, widths or heights, other ridge designs, or even a substantially flat tray with slits for airflow.

Airflow 141a can be controlled by baffles in the basin or attached to the fan, variable fan speed, the addition of multiple fans, or by other means. The troughs 123 between the ridges 122 may similarly have slits (not shown) to allow water to fall into the interior space 112 of the base 110, where it would also dry as it is exposed to airflow 141a from the fan 141. Slots are just one example of how air can flow from the fan and basin through the slotted tray to the objects. Perforations, a series of holes, tubes, or other means could also be used.

The slotted drying tray 120 rests on the base 110 and is fully removable. The slotted drying tray 120 may be secured via a multitude of ways, including but not limited to threaded fasteners, snap-fit or press-fit, magnets, Velcro (hook and loop), adhesives, interlocking geometry, straps or bands, hinges with pins or latches, sliding rail or track systems, suction or vacuum cups. The fan 141, the base 110, and the slotted drying tray 120 are separate components, and can be disassembled to allow for the base 110 and slotted drying tray 120 to be washed and sanitized. The base 110 and slotted drying tray 120 can be put in the washing machine, while the waterproof fan 141 can be rinsed. The fan 141 slides into the base and is snuggly secured via rotating clips, though it could also be secured with an alternate method, including but not limited to screws or clips. The fan, of which there could be one or multiple, could also be arranged in several ways, including on the side of the base 110, under the base 110, or even above the base 110. The fan or fans could be powered by plug in power, or single use or rechargeable batteries. The fan or fans 141 could also have multiple speeds to allow for varying airflow settings.

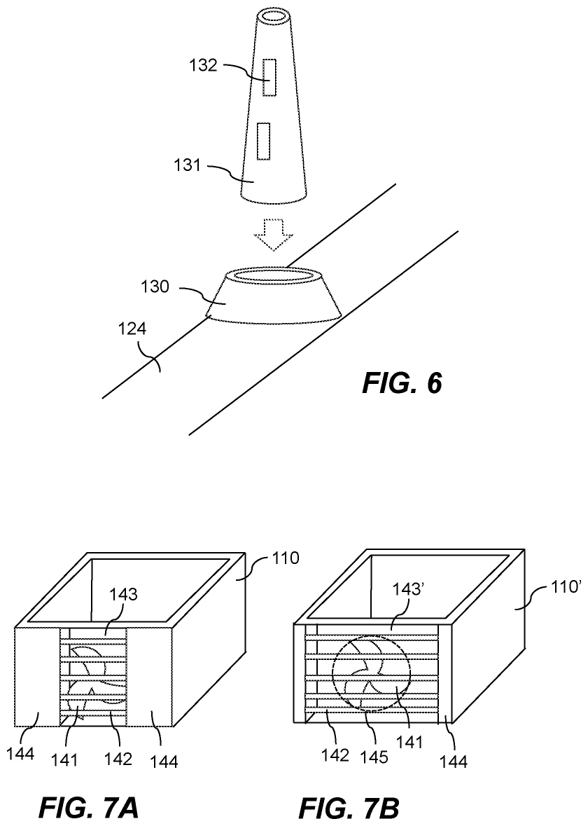

Referring to FIGS. 1-4, the rack system 100 further includes one or more pegs 130 mounted on the through openings 124 of the ridges 122 and one or more poles 131 respectively installed on the one or more pegs 130. The poles 131 extend upwardly from the pegs 130 and are configured to be coupled to the objects placed on the tray 120. With reference to FIG. 6, shown is exemplary structure of the peg 130 and pole 131, in which the peg 130 has a tapered hollow cylinder shape and the pole 131 has a hollow cylinder shapes and includes one or more holes 132 formed on a side of the hollow cylinder shapes of the pole 131. The holes 132 are open to the interior space 112 of the base 110 through the through openings 124 of the ridge 122.

The pegs 130 taper inwards and allow the air to flow through. A separate pole 131, which is tapered at the bottom so its base can fit easily around the top of the peg 130, fits snuggly on the peg 130 when it is pushed down firmly and is secured via friction. There are holes at or near the top of the pole 131. The curvature on the bottom of the removable pole 131 follows the curvature of the ridge 122 and peg 130, so when pressed down air is directed into the pole 131. Bottles or bags can be placed upside down over the pole 131 to direct airflow deeper into the object and accelerate drying. The poles could also be attached via clips, threads, locks, latches, magnets, pins, or by other means.

FIG. 6 is an exemplary view showing pole 131 inserted into peg 130. The pegs 130 can be placed anywhere. The poles 131 may be directly placed on the through openings 124 without pegs 130. The poles 131 can be installed in the through openings 124 by using any structures and methods. Moreover, in another embodiment, the through openings 124 may have a closed structure when poles 131 are not installed. When the pole 131 is installed, the through openings 124 are opened. In other words, attaching of the pole 131 opens the through opening 124 that is otherwise closed.

In an embodiment, pegs 130 can be attached or removed from the slotted tray 120. The pegs 130 may or may not allow air to flow through. An alternative peg design shows pegs that are or are not removable, but are hinged and can be laid flat on the tray when not in use.

With legs (not shown) in each of the four (4) corners of the slotted drying tray 120, the multiple slotted drying trays can be stackable, increasing the number of items that can be dried in the same square footage of counter space.

With reference to FIGS. 7A-7B, shown are diagrams illustrating configurations of fan 141 installed in the base 110. Referring to FIG. 7A, safety bars 142 are placed on the air intake opening 143 in front of the fan 141, so that large objects cannot hit and interfere with the fan 141. The safety brackets or side wall 144 of the base 110 indicate where air can flow through the air intake opening 143 into the base 110. The surface area of the air intake opening 143 is substantially the same as the surface area of the cross section of the fan intake, so air can only move into the base through the fan 141.

Referring to FIG. 7B, the air intake opening 143′ extends beyond the cross section of the fan 141, and air can flow into the base 110 through the fan 141 and the space between the side walls 144, which extends beyond the fan 141. In other words, the area of the air intake opening 143′ is much greater than the effective area 145 of the fan 141. For example, the area of the air intake opening 143′ may be more than 1.5 times, 2.0 times, 2.5 times, or 3.0 times greater than the effective area 145 of the fan 141. This design can allow for more air to flow into the base 110. Based on the Bernoulli Principle, as the speed of air increases, its pressure decreases. In addition, air will move from a high pressure area to a low pressure area. Because of this, as the fan 141 pulls air through the larger air intake opening 143′ and increases the air speed, the pressure of the air decreases. Additional air moves toward the low pressure air, and is thus pulled into the base 110 through the surrounding space.

In alternative embodiments, there may be a slot for a removable filter before the fan intake to catch dust and other particles. The filter is removable to be cleaned or replaced. The fan unit 140 may have a removable or permanent rechargeable battery. The through openings 124 in the slotted tray 120 may be closed to redirect airflow when there are no objects on them that require drying. This structure may increase airflow through other through openings 124. A small tab (not shown) on the tray 120 that rises above the edge of the base 110 makes it easier to separate the tray 120 from the base 110. The slotted tray 120 is set below the edge of the base 110, so there is a perimeter around it. This barrier ensures objects do not get pushed off the edge. The tray 120 may be made of flexible material and rolled up. The sides of the base 110 may be angled out as they rise, so that the bases 110 can be stacked.

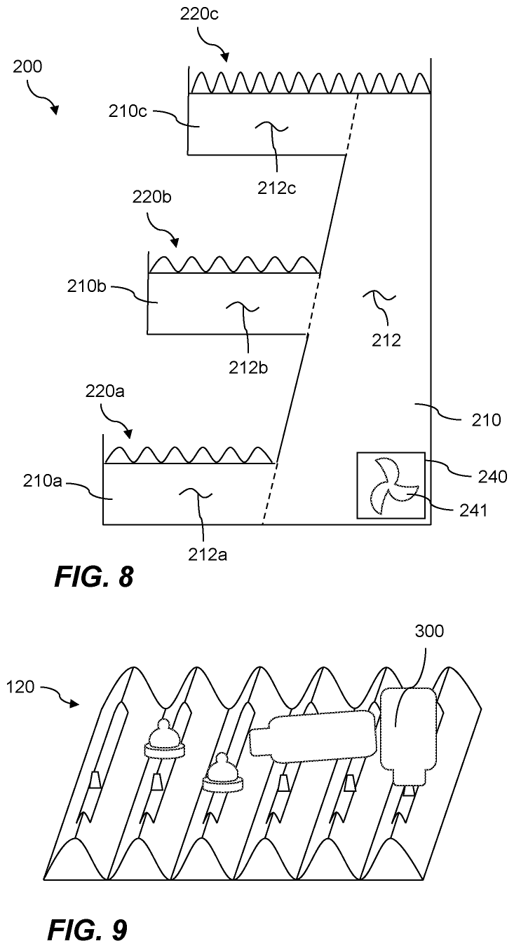

With reference to FIG. 8, shown is another embodiment of the rack system 200 (or tower rack system 200) of the disclosed invention. The rack system 200 includes main base 210 that defines main interior space 212. The main base 210 includes one or more tray bases 210a, 210b, 210c installed on the main base 210. The tray bases 210a, 210b, 210c respectively provide tray base interior spaces 212a, 212b, 212c and have open top surfaces open to the respective tray base interior spaces 212a, 212b, 212c. Each of the tray bases 210a, 210b, 210c may have the same structure as the base 110 described referring to FIGS. 1-4, except that the tray base interior spaces 212a, 212b, 212c are open to the main interior space 212.

The rack system 200 includes one or more trays 220a, 220b, 220c configured to be respectively placed on the tray bases 210a, 210b, 210c. Each of the trays 220a, 220b, 220c may have the same structure as the tray 120 described referring to FIGS. 1-4. Each tray 220a, 220b, 220c covers the tray base interior space 212a, 212b, 212c of the corresponding tray base. The tray bases 210a, 210b, 210c are arranged vertically along the height of the main base 210. The main base 210 may be tapered along the height of the main base 210. The tray bases 210a, 210b, 210c may or may not be removable from the main base 210. The main base 210 may be tapered to increase airflow to the higher tray bases. The rack system 200 includes one or more fan units 240 that include one or more removal fans 241.

With reference to FIG. 9, shown is a diagram illustrating how items or objects 300 may be placed on the tray 120 to dry the items. The items 300 rest on the peaks of the slotted ridges of the tray 120. The items are exposed to active airflow generated from the fan that travels through the base and the slots in the ridges. The items are suspended above the troughs and resting across multiple slotted peaks, creating space for airflow and allowing water to flow down and away from the drying items.

The rack system 100, 200 of the disclosed invention provides the following features and advantages: (i) open air design minimizes moisture entrapment and reduces mold and bacteria risk, (ii) a modular fan, base, and tray are detachable, and allows for easy cleaning of all parts, (iii) a slotted drying tray rests on top of, or fastens to, the base, (iv) a ridged surface on the drying tray minimizes contact points for enhanced airflow and accommodates a wide range of item sizes, (v) slits or slots along the peaks of the ridges allow active airflow generated by the fan to penetrate components, and (vi) angled troughs between the ridge peaks enhance water runoff.

One example of use of the rack system 100, 200 includes drying baby bottles, nipples, pacifiers, breast pump parts and teethers of varying shapes and sizes. Other uses include drying objects like drinking glasses or other common household kitchen objects, as well as applications for drying medical or lab items such as beakers, test tubes, pipettes, or graduated cylinders.

Since many modifications, variations, and changes in detail can be made to the described preferred embodiments of the invention, it is intended that all matters in the foregoing description and shown in the accompanying drawings be interpreted as illustrative and not in a limiting sense. Consequently, the scope of the invention should be determined by the appended claims and their legal equivalents.

What is claimed is:

1. A rack system configured to dry objects, comprising:
a base providing an interior space and having an open top surface open to the interior space;
a tray placed on or inside the base, covering the interior space of the base, wherein the tray comprises a plurality of protruding portions, wherein one or more of the protruding portions include at least one through opening that is open to the interior space of the base; and
at least one fan unit coupled to the base and comprising at least one fan configured to provide an airflow into the interior space of the base.

2. The rack system of claim 1 wherein the tray further comprises a channel placed at a first end of the tray to collect fluid flowing through the tray.

3. The rack system of claim 1 wherein the protruding portions comprise a plurality of ridges spaced apart from each other extending between a first end of the tray and a second end of the tray and a plurality of troughs between the plurality of ridges.

4. The rack system of claim 3 wherein bottoms of the troughs along a line between the first and second ends of the tray are inclined with respect to a surface of the base.

5. The rack system of claim 3 wherein peaks of the ridges along a line between the first and second ends of the tray are parallel to a surface of the base.

6. The rack system of claim 1 further comprising one or more poles extending upwardly from the tray and configured to be coupled to the objects placed on the tray.

7. The rack system of claim 6 wherein the poles have hollow cylinder shapes and includes holes formed on a side of the hollow cylinder shapes of the poles, and the holes are open to the interior space of the base through the through openings of the ridges.

8. The rack system of claim 1 wherein the at least one through opening comprises one or more slots.

9. The rack system of claim 1 wherein the at least one through opening comprises one or more holes.

10. The rack system of claim 1 wherein the tray is detachably placed on the base.

11. The rack system of claim 1 wherein the fan is detachable from the fan unit.

12. A rack system configured to dry objects, comprising:
a main base providing a main interior space and comprising one or more tray bases installed on the main base, wherein each tray base provides a tray base interior space and has an open top surface open to the tray base interior space, wherein the tray base interior spaces of the one or more tray bases are open to the main interior space;
one or more trays configured to be placed on or inside the tray bases, wherein the tray comprises a plurality of protruding portions, wherein one or more of the protruding portions include at least one through opening that is open to the tray base interior space of the corresponding tray base; and
at least one fan unit coupled to the main base and comprising at least one fan configured to provide an airflow into the main interior space of the main base.

13. The rack system of claim 12 wherein the tray bases are arranged vertically along a height of the main base.

14. The rack system of claim 12 wherein the main base is tapered along a height of the main base.

15. The rack system of claim 12 wherein the tray bases are detachable from the main base.

16. The rack system of claim 12 wherein the tray further comprises a channel placed at a first end of the tray to collect fluid flowing through the tray.

17. The rack system of claim 12 wherein the protruding portions comprise a plurality of ridges spaced apart from each other extending between a first end of the tray and a second end of the tray and a plurality of troughs between the plurality of ridges.

18. The rack system of claim 17 wherein bottoms of the troughs along a line between the first and second ends of the tray are inclined with respect to a surface of the base.

19. The rack system of claim 12 further comprising one or more poles extending upwardly from the tray and configured to be coupled to the objects placed on the tray.
